(19) United States
(12) Patent Application Publication
(10) Pub. No.: US 2013/0297821 A1
(43) Pub. Date: Nov. 7, 2013

(54) CLIENT BASED CONGESTION MANAGEMENT

(71) Applicant: Absio Corporation, Littleton, CO (US)

(72) Inventors: Mitchell J. Tanenbaum, Littleton, CO (US); Daniel L. Kruger, Evergreen, CO (US)

(73) Assignee: Absio Corporation, Littleton, CO (US)

(21) Appl. No.: 13/886,110

(22) Filed: May 2, 2013

Related U.S. Application Data
(60) Provisional application No. 61/641,745, filed on May 2, 2012.

(51) Int. Cl. H04L 12/70

(52) U.S. Cl. CPC H04L 47/10
USPC 709/235

(57) ABSTRACT

Systems and methods for network congestion management are provided. More particularly, network congestion management is performed by client devices, on the edge of the network. A client device can execute a client agent that is responsible for determining whether an item of content can be delivered to a network for delivery to a recipient system or device. The client can apply a category assigned to an item of content according to a taxonomy, against a profile, to determine whether the item of content can be sent immediately, or whether the content needs to be queued for sending at a later time.

### CROSS REFERENCE TO RELATED APPLICATIONS

This application claims the benefit of U.S. Provisional Patent Application Ser. No. 61/641,745, filed May 2, 2012, the entire disclosure which is hereby incorporated herein by reference in its entirety.

### FIELD

The present disclosure is generally directed to network congestion management. More particularly, systems and methods that implement congestion management at a network client are provided.

### BACKGROUND

Bandwidth congestion is an issue for all types of networks. Network bandwidth congestion typically comes from having more “edge” capacity than “core” capacity, and when the instantaneous edge demand is more than the maximum sustained core capacity. In particular, when the bandwidth of a network is approached or exceeded, the ability of the network to deliver data on behalf of end points is compromised. For example, in TCP/IP networks, data packets that the network is unable to deliver are discarded. In other cases, the effective bandwidth available to individual users can become so limited that it becomes a practical impossibility for a client device to send or receive information using the network.

In a typical network, the carrier is responsible for dealing with bandwidth congestion issues. Moreover, the management of such issues is performed in the core network. As a result, all traffic must be analyzed by the core network to determine how that traffic will be handled. For example, traffic can be placed in queues until demands on the network have subsided, and capacity for delivering the data becomes available.

Systems have been developed that attempt to identify a priority associated with items of data, and handle that data accordingly. For example, the GETS and WPS systems developed primarily for use in connection with voice traffic, provide registered users with assigned priority levels. However, such systems cannot distinguish between different types or subjects of data associated with a particular user. In addition, it is difficult or impossible for a conventional congestion management system to prioritize encrypted data. Conventional congestion management systems are also generally not compatible with systems used by unregistered users, where the identities of individual users are not known, and/or where dynamic control of congestion management parameters is desirable.

### SUMMARY

Embodiments of the present disclosure are directed to solving these and other problems and disadvantages of previous systems and methods for network congestion management. In accordance with the embodiments of the present disclosure, network client edge devices (hereinafter referred to as clients) are provided with an agent or application that implements network congestion management functions. More particularly, the client application applies a profile to determine whether, based on a classification of a particular item of content, that item of content is to be presented to the network for delivery to a recipient system or device. The classification of items of content can be performed by the user, the client application, or some other application (e.g. an application used to create and/or edit the content). Moreover, the classification can be in accordance with a taxonomy for classification accessible to the client application. The profiles applied by the client application provide the rules that determine whether, at a particular moment in time, an item of content will be presented to the network by the client device. Multiple profiles can be referenced and applied in connection with a determination as to whether a particular item of content should be presented to the network. A profile can be created by a user, a carrier or network provider, a network manager, a virtual network (for example but not limited to a virtual private network) manager, or the like. Moreover, a different profile or set of profiles can be provided to different users, based on the credentials of the user. In addition, profiles can be changed in real time, and profiles can be changed as a result of automated processes performed by a network or other central congestion management system. In accordance with still other embodiments, an override function can be provided, to enable a user or system to apply prioritized handling to emergency messages or other data.

Methods in accordance with embodiments of the present disclosure include creating content or data (hereinafter content), or collections of content. The content may then be mapped to a taxonomy. The taxonomy provides a classification scheme according to which the content or collection of content is assigned a category, classification or priority. Different categories can have different relative priorities. Next, a request to send the content to a recipient is generated. In response to the request, the content is mapped to the applicable profile or profiles. More particularly, the category associated with the content and/or metadata, such as but not limited to the size of the file or files comprising the content, is considered. The profiles contain the rules that are applied by the client application in determining whether the content is to be presented to the network for delivery to a recipient. If multiple profiles exist, they are overlaid to create one merged profile. Between profiles, priorities can be assigned. For example, a carrier profile can be assigned the highest priority because only the carrier has visibility to network congestion. Alternatively, a locally created profile can be assigned the highest priority on the grounds that only the user of a client device understands the relative priority of the data. In general, a profile is constructed so that content assigned a higher relative priority by the taxonomy, is more likely to be presented to the network for transmission to a recipient with no or little delay, as opposed to lower priority content. In addition, profiles can treat content differently based on attributes that are in addition to and/or that are not captured within a classification assigned to the content by the taxonomy. For example, the identity of the sender, the time of day, the size of the content to be sent, the geographic location of the end point, or any other parameter can be used by the profile. In accordance with further embodiments, a priority can be assigned to content solely based on a parameter or parameters that are not reflected within a taxonomy. For example, a category or classification can be assigned on the basis of parameters other than based on definitions in the taxonomy. In accordance with still further embodiments of the present disclosure, the data comprising the content itself does not need to be decoded or otherwise accessed in order to determine whether a profile will allow the content to be presented to the network, with or without delay.

In accordance with still other embodiments, client-based congestion management systems and methods are provided that allow a client to control whether a particular item of content is downloaded from the network. More particularly, where the client application has visibility into the content or traffic that is queued or otherwise awaiting delivery to the client, the client can selectively request that content be sent, or can request that the delivery of content be deferred. Decisions regarding whether to download content can be made with reference to an applicable profile or profiles, for example by applying a category or classification assigned to an item of content according to a taxonomy, and/or other parameters, to the profile or profiles.

Additional features and advantages of embodiments of the present disclosure will become more readily apparent from the following discussion, particularly when taken together with the accompanying drawings.

### BRIEF DESCRIPTION OF THE DRAWINGS

FIG. 1 is a depiction of the elements of a system in accordance with embodiments of the present disclosure;

FIG. 2 is a block diagram of a client device in accordance with embodiments of the present disclosure;

FIG. 3 is a flowchart depicting aspects of a method for managing network congestion in connection with content sent from a client device;

FIG. 4 is a flowchart depicting aspects of a method for managing congestion by controlling content delivered to a client device; and

FIG. 5 illustrates the contents of a profile in accordance with embodiments of the present disclosure.

### DETAILED DESCRIPTION

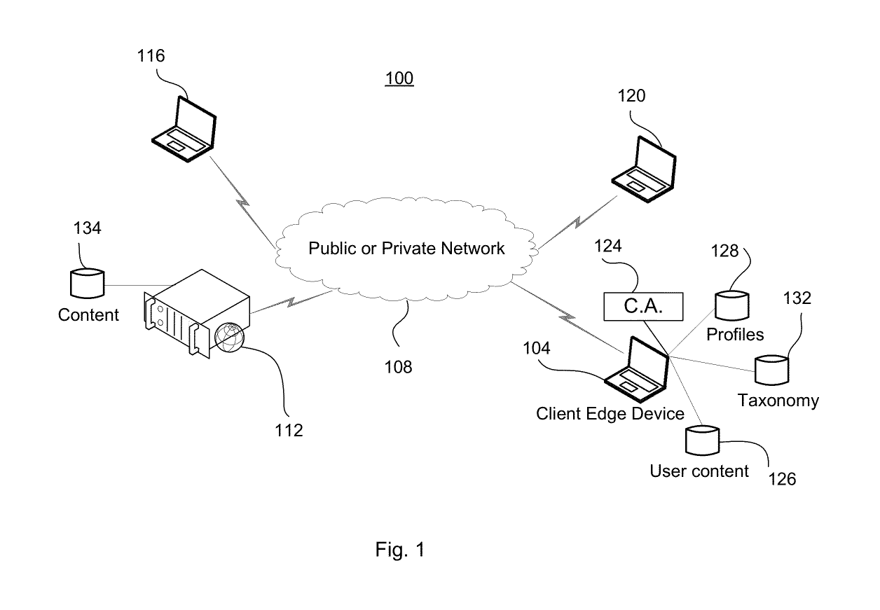

FIG. 1 depicts a system 100 for providing client based congestion management in accordance with embodiments of the present disclosure. The system generally includes one or more client edge devices 104 (hereinafter clients 104) connected to a network 108. The clients 104 are generally capable of providing content to the network 108 for delivery to a recipient device or system. The system can also include various optional components, including but not limited to a distribution control system 112, a carrier management station 116, and/or an enterprise management station 120.

In accordance with embodiments of the present disclosure, a client 104 can comprise any system or device capable of operating as a node with respect to the network 108, including but not limited to providing content to the network 108 and/or receiving content from the network 108. Accordingly, examples of a client 104 include but are not limited to, a desktop computer, a laptop computer, a smart phone, a tablet computer, a server, or other general purpose computing device. Other examples of a client 104 include special purpose devices, such as a camera, microphone, security system, environment control system, industrial control system, environmental monitor, vehicle control system, or the like. As described in greater detail elsewhere herein, the client 104 includes or has access to a client agent 124, and further includes or has access to content 126, one or more profiles 128, and a taxonomy 132.

The network 108 can comprise a network or collection of networks, and is capable of transmitting content 124 on behalf of the one or more client devices 104. In a typical implementation, the network 108 includes portions that are provided by a carrier, a commercial network provider, an enterprise network provider, a government network provider, or the like. In addition, a client device 104 can be connected to the network 108 directly, or via an intermediate network. For example, where the client 104 comprises a smart phone or other device with cellular data connectivity, the connection to a network 108 may be direct in that it utilizes a cellular data portion of a carrier providing the network 108. Moreover, networks 104 can comprise logical or virtual divisions of a physical network. For example, a network 108 may comprise a virtual private network (VPN) carried by a physical network that also carries traffic outside of the VPN. A client 104 can be connected to a network 108 through wireline or wireless access points. For example, a client 104 can be connected to a network 108 via a Wi-Fi access point that is in turn connected to the network 108 by a router.

A distribution control system 112 may comprise a server and/or data storage system connected to the network 108 that holds content or other data for delivery 134. The distribution control system 112 can maintain content for delivery 134 in associated data storage, until a request for such content is received from a client 104. In accordance with still other embodiments, a distribution control system 112 can operate like a client 104, in that the presentation of content for delivery 134 to the network 108 can be governed according to the classification of particular items of the content to be delivered 134, and the applicable profile or profiles 128, as administered by a client application running on the distribution control system 112.

A carrier management station 116 and/or an enterprise management station 120 can be provided to allow an authority or administrator to control operation of the network 108. More particularly, a management station 116 and/or 120 can be used to generate and distribute profiles 128. Moreover, the profiles 128 can be changed as factors affecting network 108 congestion change. Profiles 128 can be generated through, for example, manual user input, entered at a management station 116 and/or 120, or through automatic processes executed by a management station 116 and/or 120.

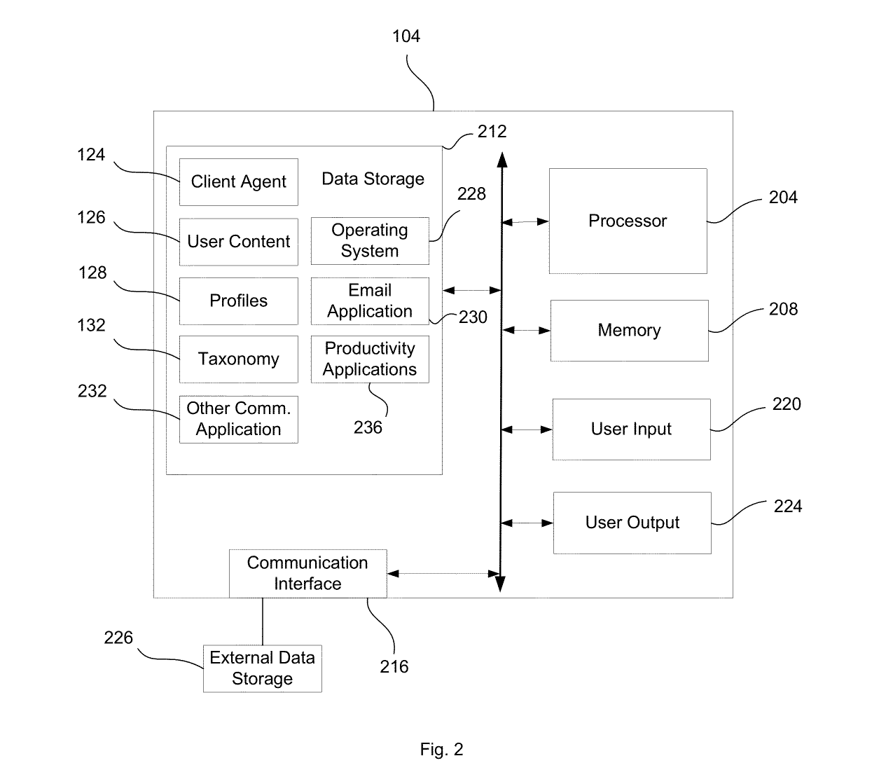

With reference now to FIG. 2, components of a client 104 in accordance with embodiments to the present disclosure are depicted. As previously noted, the client 104 can generally comprise a general purpose computer, smart phone, or other device capable of supporting communications over a network 108 and of running a suitable version of a client application 124 as disclosed herein. In general, the client 104 includes a processor 204, memory 208, data storage 212, and a communication or network interface 216. Examples of a communication interface 216 include, but are not limited to, wireline or wireless Ethernet ports, universal serial bus (USB) ports, Bluetooth modules, near field communication modules, and the like. In addition, the client 104 can include one or more input devices 220, such as a keyboard and a pointing device and one or more user output devices 224, such as a display and a speaker.

The processor 204 may include any processor capable of performing instructions encoded in software or firmware. In accordance with other embodiments of the present disclosure, the processor 204 may comprise a controller or application specific integrated circuit (ASIC). The memory 308 may be used to store programs, data, including data comprising content 126. As examples, the memory 208 may comprise RAM, SDRAM, or other solid state memory. Alternatively or in addition, data storage 212 may be provided. The data storage 212 may generally include storage for programs and data. For example, the data storage 212 may store various data and applications. For instance, with respect to a client 104, data storage 212 may provide storage for a client agent or application 124, user content 126, profiles 128, and content taxonomy 132. Data storage 212 associated with a client device 104 can also provide storage for various other programs or data, such as operating system instructions 228, an email application 230, other communication applications 232, productivity applications 236, such as word processing, spreadsheet, presentation software, or other applications and data.

Data storage 212 may comprise fixed or removable data storage, such as one or more internal hard disk drives, solid state drives, or logical partitions. In accordance with still other embodiments, external data storage 226 can be interconnected to the client 104, for example via a communication interface 216. Examples of external data storage 226 include flash memory devices, portable hard drives, and network or cloud based storage. The external data storage 226 can provide data storage for some or all of the applications and data associated with a user and/or a client 104. Accordingly, external data storage 226 can provide for storage of a client application 124, content 126, profiles 128, content taxonomy 132, or portions thereof.

Although the discussion with respect to FIG. 2 has been in relation to a client 104, it should be appreciated by one of skill in the art after consideration of the present disclosure that a distribution control system 112 can in many respects be implemented in a similar fashion. For example, a distribution control system generally includes a client application 124 for implementing rules, expressed by profiles 128 in relation to a taxonomy 132 used to assign a classification to content for delivery 134. A distribution control system can also include a client application 124 that allows requests for content initiated at a client device 104 to be received and acted upon. Accordingly, a distribution control system 112 can act autonomously, for example by applying profiles 128 to content for delivery 134 when such content becomes available, and/or on demand, in response to requests from client devices 104 for content to be delivered 134 to the requesting client 104.

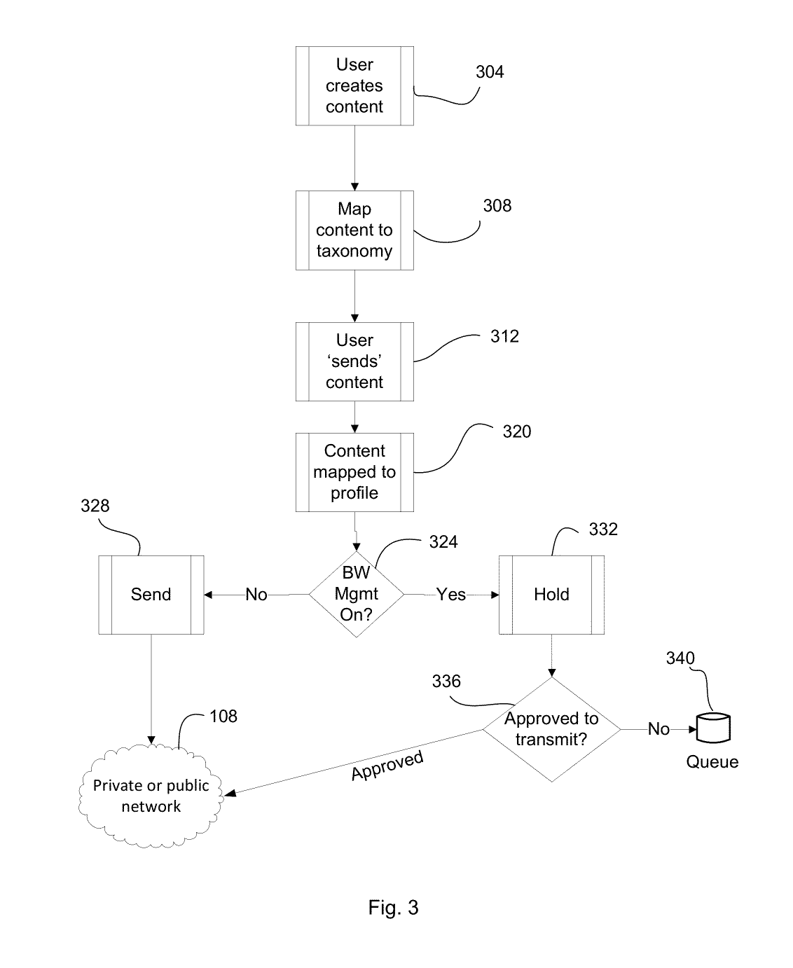

FIG. 3 is a flowchart depicting aspects of the operation of a congestion management system 100 in connection with transmitting content 124 from a client 104 to a receiving device or system via a network 108. Initially, at step 304, content 124 is stored on or made accessible to the client 104. For example, content 124 can be received at, created on, and/or edited on the client 104, and stored in data storage 212 and/or external data storage 236. At step 308, the content 124 is mapped to the taxonomy 132. In accordance with embodiments of the present disclosure, this can include the client application 124 applying parameters associated with an item or grouping of content 124 to the taxonomy 128, to determine the category or classification that should be applied to the content 124. Parameters that are relevant with respect to determining the classification set forth in the taxonomy 128 can include an urgency parameter assigned by a user, a subject of the content, size of content, file type, media type, or any other parameter, whether that parameter is intrinsic to the content 124 itself or assigned without respect to the content itself.

At step 312, a selection to send content 124 is made. The selection can be the result of a manual input from a user, or can be the result of an automated process. The content 124 is then mapped to an applicable profile or profiles 128 (step 320). More particularly, the categorization or classification associated with the content 124 according to the taxonomy 128 is applied to a profile 128, to determine the priority to be given to the content 124. A profile 128 generally contains a set of rules that determine how different categories of content 124 are to be handled. More particularly, a profile 128 provides rules regarding content 124 (data) priority. Profiles 128 can be created in various ways. For example, a profile 128 can be created locally by the user of the client 104. A profile 128 can also be created centrally by the organization controlling (owning) a client device or devices 104. Profiles 128 can also be created by the carrier or network 108 operator. If multiple profiles 128 exist, they are overlaid in a way that creates one merged profile 128. For example, a carrier profile 128 can be given the highest priority on the grounds that only the carrier has visibility to network congestion. Alternatively, a locally created profile 128 can be given the highest priority on the grounds that only the user understands the relative priority of the content 126 to be sent. In use, a profile 128 operates as a filter, that determines the priority to be accorded an item or collection of content 126. Where multiple profiles 128 are applicable, they are overlaid with one another, according to the relative priority of the different profiles 128.

At step 324, a determination can be made as to whether a bandwidth management feature of the system 100 is operational. If bandwidth management is not active, the content 126 is sent to the networks 108 via a communications engine, such as the client agent 124, an email application 230, or another communication application 232 (step 328).

If bandwidth management is active, the content 126 is placed in a queue associated with a communications engine, or is otherwise held (step 332), pending a determination as to whether transmission of the content 126 is approved (step 336). The determination regarding whether to grant a request to transmit content 126 is made by the client agent 124. Because congestion management is performed by the edge device, content 126 is considered for presentation to the network 108 on a transmission by transmission basis. Accordingly, rules contained in a profile or profiles 128 can be applied to particular items of content 126 to determine whether, based on the classification and/or other metadata, a particular item of content 126 may be presented to the network 108 for immediate delivery. If transmission is approved, the content 126 is delivered to the network 108 for transmission to a recipient device 104 or system. If transmission is not approved, the content 126 is placed in a queue 340. Therefore, where application of the rules in a profile 132 to content 126 that is categorized according to the taxonomy 132 indicates that content 126 should not be sent at that time (i.e. that presentation of the content 126 to the network 108 should be deferred), no attempt to transmit the content across the network needs to be made, and no request to transmit needs to be made to the network 108. Therefore, network resources 108 are conserved. If content 126 is placed in a queue (i.e., it is held in data storage 212 or external data storage 226), checks can periodically be made to determine whether, according to the classification assigned to the content 126 and the applicable profile or profiles 128, the content 126 can be sent. Moreover, the determination with respect to whether the content 126 is to be presented to the network 108 does not require that the client agent 124 decode or access the data comprising the content 126 itself.

As can be appreciated by one of skill in the art after consideration of the present disclosure, various operations of a method discussed in connection with the transmission of content 126 from a client 104 to a receiving client 104 system via a network 108 can be performed in different orders. For instance, determining whether bandwidth management is active can be performed as an initial step, for instance prior to mapping content 126 and the associated classification to a profile or profiles 128.

Methods for delivering content 126 as described herein can be implemented in connection with the client agent 124 running on the client 104 from or on behalf of which content 126 is to be sent. As discussed herein, the client agent 124 can apply the classification assigned to an item of content 126, according to the taxonomy 132, to the profile or profiles 128 then active, to determine whether the item of content 126 can be sent without the client agent 124 interposing a delay, or whether the content 126 should be queued for later transmission. Moreover, when content 126 is queued, checks can periodically be made by the client agent 124 to determine whether applicable profiles 128 have changed, or whether restrictions on sending the queued content 126 are no longer applicable. For example, restrictions imposed by a profile 128 on sending an item of content 126 can be set to expire after the content 126 has been held in a queue for a predetermined period of time, until a particular time of day and/or date has been reached, or any other condition, as specified by an applicable profile 128, has changed such that the content 126 can be transmitted.

As an example, in the case of a disaster during which network 108 bandwidth is stressed, video files, which are typically large, and that are taxonomically categorized as archives, may be queued on the edge device 104 and not transmitted. That rule could be created by the user, by the user's employer, for instance a newspaper or government agency or the network 108 carrier. As another example, files over a certain size (e.g., 100 MB) can be queued until 2 AM, or after a set period of time (e.g., 24 hours) determined to be sufficient for traffic on the network 108 to have subsided. As another example, the network 108 carrier could create a rule, based on infrastructure damage, that prohibits traffic other than first responder traffic to pass for some period of time (e.g. the next 60 minutes). Various other limitations or controls, encoded by profiles, or through the substitution of profiles 128, can be used.

Profiles 128 can be delivered by the network 108 to any connected device 104 in real time, and changed in real time or near real time, including in an automated fashion, by the carrier or other network 108 authority. For example, revised profiles 128 can be sent to devices 104 based on network 108 conditions, as determined by the carrier's network base congestion management system.

To ensure that emergency traffic is not quarantined, the client agent 124 on the client 104 that manages the client base network congestion management solution provided by embodiments of the present disclosure can provide for an emergency override. By selecting an emergency override, a user can ensure that the content 126 be given special status.

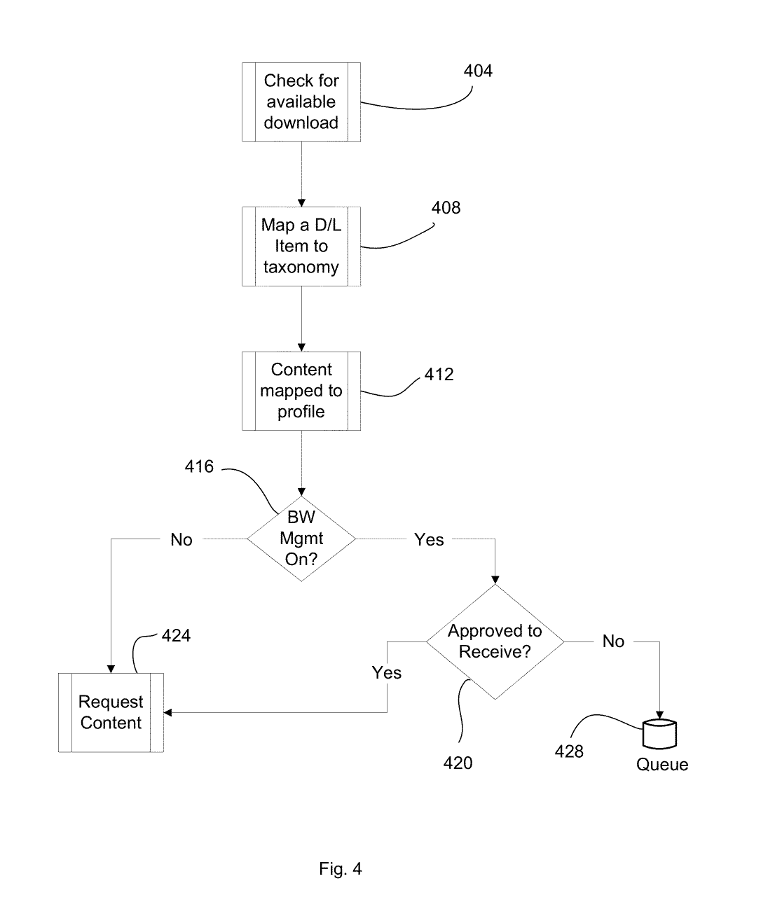

With reference now to FIG. 4, aspects of a method for managing congestion by controlling content delivered to a client device 104 are depicted. Initially, at step 404, a client agent 124 running on a client 104 checks for the availability of content 134 to be downloaded from a distribution control system 112. For example, in accordance with at least some embodiments of the present disclosure, a client agent 124 may be provided with a list or other indication of content 134 available for download. Such a list can be pushed to the client 104 by the distribution control system 112, can be generated as a result of a query initiated at the client 104, or can be otherwise provided. Metadata concerning the content 134 can be applied to map that item of content 134 to the taxonomy 132, to obtain a classification of the content 134 for purposes of determining whether the content 134 can be delivered to the client 104 by the network 108 immediately, or whether that content should continue to be held by the distribution control system 112. Alternatively, a classification can be assigned to the item of content 134 by a sending device, by the distribution control system 112, or some other component of the system 100.

At step 412, the content 134, and in particular the classification assigned to that content 134, is mapped to the applicable profile or profiles 128. Mapping the content 134 to the profile or profiles 128 can be performed by the client agent 124 running on the client device 104 that is to receive the content 134.

At step 416, a determination can be made as to whether bandwidth management functions with respect to the network 108 are active. If bandwidth management is active, the client agent 124 can determine whether the client 104 is approved to receive the content 134 (step 420). If the client 104 is approved to receive the content 134, or stated another way, the rules set forth in the profile 128 allow the content 134 to be sent over the network 108, the client agent 124 can send a request to the distribution control system 112 to proceed with sending the content 134 via the network 108 (step 424). Similarly, if bandwidth management is not active, the client agent 124 can request the content 134, for example via a communications engine, in response to which the content 134 is sent via the network 108 to the client 104. Alternatively, if the client 104 is not approved to receive the content 134 immediately, the content 134 can be queued at the distribution control system 112 (step 428). Periodic checks can then be made as to whether applicable profile 128 conditions and/or parameters associated with the decision to queue the content 134 have changed, thereby allowing the content 134 to be delivered. Such periodic checks can be initiated by the client agent 124. Although the process discussed in connection with FIG. 4 has set forth various steps in a particular order, it should be appreciated that different orderings of the steps and/or additional steps can be implemented.

In accordance with embodiments of the present disclosure, network congestion management can, at least in part, be performed through the execution of a client agent 124 by a client 104. Centralized control can be maintained through the distribution of profiles 128 used to control the sending of data. However, decisions with respect to the transmission of individual items of content 126 and/or 134 can be made by the client agent 124. Moreover, such decisions can be made without requiring input from a central authority with respect to a particular item of content 126 and/or 134 at the time the decision of whether to transmit that item of content 126 or 134 is made. Accordingly, network resources can be conserved. In addition, the control of content delivery through the use of a client agent 124 allows information known to the client agent 124, but not necessarily to the network 108, to be used in determinations regarding whether to deliver content 126 and 134 via a network 108.

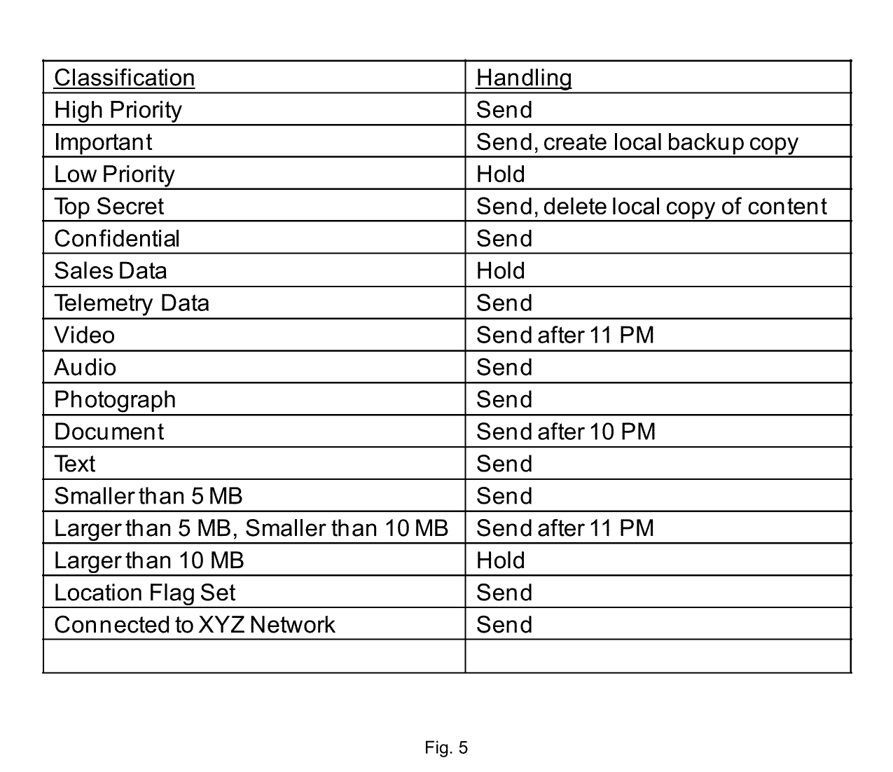

FIG. 5 depicts the contents of an example profile 128 in accordance with embodiments of the present disclosure. In a first column, examples of different classifications or categorizations that can be associated with an item of content 126 or 134 are listed. An example rule for handling content 126 or 134, shown in a second column, is associated with each of the categorizations. The categorization of an item of content 126 or 134 can be determined according to a taxonomy 132, which defines the rules of categorization. The categorization can relate to a relative importance of the content 126 or 134, such as “high priority”, “important”, or “low priority”. The categorization can also relate to some attribute of the information contained in the content 126 or 134, such as “top secret”, “confidential”, “sales data”, “telemetry data”, etc. Alternatively or in addition, the categorization can relate to the type of data comprising the content 126 or 134 itself, such as “video”, “audio”, “photograph”, “document”, or “text”. A size can also be a parameter related to a handling rule by a profile 128. For example, a maximum size, size range, or minimum size can all be associated with a specified handling rule. According to still other embodiments, a categorization can relate to a geographic location of the client 104 and/or the source of the content 126 or 134. For example, a client agent 124 can receive location information from a client 104 device, such as a global positioning system (GPS) receiver, and/or from the network 108, and can use that information to determine whether to set (or not set) a location flag. The profile 128 can then include a rule for handling content 126 or 134 when a location flag is set and/or not set. As another example, a categorization can relate to the status or rank of the user of the client 104. A categorization can also be assigned to an item of content by a user, or by some other authority. Other classifications or categories are possible. In addition, a classification or category is not required to originate from a taxonomy 132. For example, metadata concerning an item of content 126 or 134, such as the size or type of the content can be determined separately or according to a different classification scheme.

The rules for handling different categorizations of content 126 or 134 dictated by a profile 128 can comprise directions for handling content 126 or 134 that are not limited to sending or holding the content 126 or 134. For example, a rule can specify that content 126 or 134 be held until some period of time has elapsed, until a particular time of day and/or date has been reached, until the client 104 has reached a particular geographic location, until the client 104 has gone into a particular operating mode, until a communication interface 216 is connected to a particular access point or network 108, or any other condition. A rule can also direct that other operations be performed. For example, a rule can specify that a copy of an item of content 126 or content metadata is to be stored in data storage 212 on the client 104 (or erased from data storage 212 and memory 208), in addition to presenting the content 126 to the network for delivery as part of a executing a “send” rule. In accordance with still other embodiments, where multiple categories apply to a single item of content 126 and 134, the rules for the different categories can be applied hierarchically. For example, a rule to send content 126 having a “priority” categorization might be given priority over a rule to hold content 126 comprising “video” where both the “priority” and “video” categorizations apply to the content 126.

In accordance with embodiments of the present disclosure, profiles 128 can be renewed and/or substituted frequently. For example, a new profile 128 can be delivered to client agents 124 as network 108 conditions change, in real time or near real time. For instance, a new profile 128 can be generated automatically, for example at a carrier management station 116 or an enterprise management station 120, in response to detecting changes in network 108 loads. Alternatively or in addition, new or revised profiles 128 can be created and distributed to clients 104 for application by client agents 124 in response to emergency situations, or other conditions that affect network 108 traffic. Profiles 128 can also operate autonomously or semi-autonomously with respect to a client 104. For example, a client 104 and/or a user can provide information regarding the location of the client to the client agent 124, which can interact with a profile 128 to change parameters applied to determinations regarding the handling of content 124 based on a current or anticipated location of the client 104. Rules regarding when such aspects of a profile 128 change can be encoded as part of the profile 128 and/or the client application 124. In general, a classification or other parameter associated with content 126 is applied to a profile 128 by a client agent 124 to determine whether the content 126 can be presented to a network 108 for delivery at that time. In addition or as an alternative to a binary type decision to send or to not send content 124, a profile 128 can determine that the content 124 should be queued for some specified period of time, and/or can specify other conditions, such as holding the content 126 in a queue until some later time and/or date. Moreover, when new profiles 128 are received, a client agent 124 can operate to consider queued content 126 for presentation to a network 108 when or after the new profile 128 is received.

In accordance with still other embodiments, the user of a client 104 may be prohibited from altering the classification assigned to an item of content 126, a profile 128, and/or a client agent 124. Accordingly, an authority can exercise control over the use of a network 108 for delivering content 126 and/or 134. Moreover, because the resources of the client 104 are utilized, the impact on resources of the network 108 itself in connection with congestion management can be reduced as compared to arrangements in which congestion management is managed centrally.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for managing network congestion, comprising:
mapping first content to a taxonomy, wherein the first content is categorized according to the taxonomy;
applying the determined category of the first content to at least a first profile; and
determining whether to transmit the first content based on rules included in the first profile and the determined category of the first content.

2. The method of claim 1, wherein the determined category of the first content is applied to the first profile by an agent running on a first client.

3. The method of claim 2, wherein the first content is mapped to the taxonomy by the first client.

4. The method of claim 2, wherein the first content is mapped to the taxonomy by a user of the first client.

5. The method of claim 2, wherein determined category of the first content is applied to a plurality of profiles.

6. The method of claim 5, wherein the plurality of profiles are applied in a hierarchical order.

7. The method of claim 2, wherein the first content is stored on the first client.

8. The method of claim 2, wherein the rules included in the first profile include a rule related to the determined category of the first content.

9. The method of claim 8, wherein the taxonomy includes a plurality of categories, and wherein the first content is associated with a first category by the taxonomy.

10. The method of claim 9, wherein the plurality of categories are arranged in a hierarchy.

11. The method of claim 1, further comprising:
determining that the rules included in the first profile and the determined category of the first content permit the first content to be presented to the network for delivery to a recipient.

12. The method of claim 2, further comprising:
determining that the rules included in the first profile and the determined category of the first content do not allow the first content to be presented to the network, wherein the first content is queued on the client.

13. The method of claim 1, wherein the determined category of the first content is applied to the first profile by an agent running on a distribution control system.

14. The method of claim 13, further comprising one of:
determining that the rules included in the first profile permit the first content to be presented to the network for delivery to a client; or
determining that the rules included in the first profile do not allow the content to be presented to the network, wherein the first content is queued on the distribution control system.

15. A content distribution system, comprising:
a client device, including:
data storage, wherein at least a first client application and first content are stored in the data storage; and
a processor, wherein the processor operates to the execute the first client application, wherein the first client application is operable to:
apply a first category associated with the first content to at least a first profile,
determine whether to present the first content to a network depending on rules included in the first profile and the first category.

16. The system of claim 15, further comprising:
communication interface, wherein in response to a determination that the first content can be presented to the network, providing the first content to the communication interface.

17. The system of claim 15, wherein in response to a determination that the first content cannot be presented to the network, queuing the first content on the client device.

18. The system of claim 15, further comprising:
a distribution control system, wherein second content is associated with the distribution control system, and wherein a second category is associated with the second content, wherein the second category is applied to the first profile by the client application, and wherein a determination of whether to deliver the second content to the client is made depending on the rules included in the second profile and the second category.

19. The system of claim 18, wherein in response to determining that the second content should not be delivered to the client the second content is queued on the distribution control system.

20. A client based system for network congestion management, comprising:
a network;
a client operatively connected to the network, the client including:
a processor;
data storage;
a client application stored in the data storage and executed by processor, wherein the client application is operable to apply a categorization of first content to a first profile containing a set of rules, wherein the first profile determines whether the first content can be presented to the network for delivery to a recipient; and
a communication interface, wherein the client is connected to the network by the communication interface.
